(19) United States
(12) Patent Application Publication
(10) Pub. No.: US 2024/0323496 A1
(43) Pub. Date: Sep. 26, 2024

(54) METHOD AND SYSTEM FOR PROVIDING TIMESTAMP MARKERS IN CONTENT ITEMS

(71) Applicant: Aubrey Channel Deloney, Lawrenceville, GA (US)

(72) Inventor: Aubrey Channel Deloney, Lawrenceville, GA (US)

(21) Appl. No.: 18/614,360

(22) Filed: Mar. 22, 2024

Related U.S. Application Data
(60) Provisional application No. 63/491,686, filed on Mar. 22, 2023.

(51) Int. Cl. H04N 21/81

(52) U.S. Cl. CPC H04N 21/8126

(57) ABSTRACT

Disclosed herein is a method for providing timestamp markers in content items. The method comprises the steps of receiving a content item; receiving a timestamp generating command from a first user device; generating a timestamp marker that marks a time point in the content item upon receiving the timestamp generating command; storing the timestamp marker; receiving a timestamp retrieving command from the first user device; and retrieving the timestamp marker upon receiving the timestamp retrieving command to allow playback from the time point. A corresponding system is also disclosed.

### FIELD OF THE INVENTION

Generally, the present disclosure relates to the field of data processing. More specifically, the present disclosure relates to methods and systems for providing a means for annotating specific points within streaming video/movies/tv shows/news shows/sport shows.

### BACKGROUND OF THE INVENTION

When a user watches a piece of media content such as a movie, television show, or sports program, the user may wish to mark a particular location in the media content that represents high user interest. Some media playing devices will remember the location at which the user stopped watching such that the user can easily pick up from exactly that location in the media content. However, this technique is limited in that it only remembers a single location in the media content, as opposed to multiple locations of interest in the media content. Moreover, the location at which the user stopped watching does not necessarily reflect a location of high user interest. In contrast, that location might actually represent low user interest.

Some techniques allow users to explicitly create bookmarks, and thus may allow a user to mark locations of high user interest. Having to create the bookmarks explicitly might be acceptable when a user is browsing the Internet because the user needs to perform other explicit actions anyway, such as moving on to another web page. Thus, the added action of explicitly creating a bookmark is not too onerous. However, for other applications having to explicitly mark a location of user interest could be quite tedious for the user. The present invention aims to solve some of these problems by disclosing a platform for providing content items.

Therefore, it is an objective of the present invention to provide a means that overcomes the problems set forth above.

### BRIEF SUMMARY OF THE INVENTION

This summary is provided to introduce a selection of concepts in a simplified form, that are further described below in the Detailed Description. This summary is not intended to identify key features or essential features of the claimed subject matter. Nor is this summary intended to be used to limit the claimed subject matter's scope.

Disclosed herein is a method for providing timestamp markers in content items. The method comprises the steps of receiving a content item; receiving a timestamp generating command from a first user device; generating a timestamp marker that marks a time point in the content item upon receiving the timestamp generating command; storing the timestamp marker; receiving a timestamp retrieving command from the first user device; and retrieving the timestamp marker upon receiving the timestamp retrieving command to allow playback from the time point.

According to some embodiments, a system for providing timestamp markers in content items. The system may comprise a processor and a memory. Modules are stored on the memory for execution by the processor. The modules may comprise a timestamp marker generating module and a timestamp marker management module. The timestamp marker generating module may be configured for receiving a content item; receiving a timestamp generating command from a first user device; and generating a timestamp marker that marks a time point in the content item upon receiving the timestamp generating command. The timestamp marker management module may be configured for storing the timestamp marker; receiving a timestamp retrieving command from the first user device; and retrieving the timestamp marker upon receiving the timestamp retrieving command to allow playback from the time point.

Both the foregoing summary and the following detailed description provide examples and are explanatory only. Accordingly, the foregoing summary and the following detailed description should not be considered to be restrictive. Further, features or variations may be provided in addition to those set forth herein. For example, embodiments may be directed to various feature combinations and sub-combinations described in the detailed description.

### BRIEF DESCRIPTION OF DRAWINGS

The accompanying drawings, which are incorporated in and constitute a part of this disclosure, illustrate various embodiments of the present disclosure. The drawings contain representations of various trademarks and copyrights owned by the Applicants. In addition, the drawings may contain other marks owned by third parties and are being used for illustrative purposes only. All rights to various trademarks and copyrights represented herein, except those belonging to their respective owners, are vested in and the property of the applicants. The applicants retain and reserve all rights in their trademarks and copyrights included herein, and grant permission to reproduce the material only in connection with reproduction of the granted patent and for no other purpose.

Furthermore, the drawings may contain text or captions that may explain certain embodiments of the present disclosure. This text is included for illustrative, non-limiting, explanatory purposes of certain embodiments detailed in the present disclosure. FIG. 1 is an illustration of an online platform consistent with various embodiments of the present disclosure.

FIG. 2 is a block diagram of a system for providing timestamp markers in content items, in accordance with some embodiments.

FIG. 3 is a flowchart of a method for providing timestamp markers in content items, in accordance with some embodiments.

FIG. 4 is a flowchart of an alternative method for providing timestamp markers in content items, in accordance with some embodiments.

FIG. 5 is a flowchart of a method for sharing the timestamp markers, in accordance with some embodiments.

FIG. 6 is a flowchart of a method for implementing group watching, in accordance with some embodiments.

### DETAIL DESCRIPTIONS OF THE INVENTION

As a preliminary matter, it will readily be understood by one having ordinary skill in the relevant art that the present disclosure has broad utility and application. As should be understood, any embodiment may incorporate only one or a plurality of the above-disclosed aspects of the disclosure and may further incorporate only one or a plurality of the above-disclosed features. Furthermore, any embodiment discussed and identified as being “preferred” is considered to be part of a best mode contemplated for carrying out the embodiments of the present disclosure. Other embodiments also may be discussed for additional illustrative purposes in providing a full and enabling disclosure. Moreover, many embodiments, such as adaptations, variations, modifications, and equivalent arrangements, will be implicitly disclosed by the embodiments described herein and fall within the scope of the present disclosure.

Accordingly, while embodiments are described herein in detail in relation to one or more embodiments, it is to be understood that this disclosure is illustrative and exemplary of the present disclosure, and are made merely for the purposes of providing a full and enabling disclosure. The detailed disclosure herein of one or more embodiments is not intended, nor is to be construed, to limit the scope of patent protection afforded in any claim of a patent issuing here from, which scope is to be defined by the claims and the equivalents thereof. It is not intended that the scope of patent protection be defined by reading into any claim limitation found herein and/or issuing here from that does not explicitly appear in the claim itself.

Thus, for example, any sequence(s) and/or temporal order of steps of various processes or methods that are described herein are illustrative and not restrictive. Accordingly, it should be understood that, although steps of various processes or methods may be shown and described as being in a sequence or temporal order, the steps of any such processes or methods are not limited to being carried out in any particular sequence or order, absent an indication otherwise. Indeed, the steps in such processes or methods generally may be carried out in various different sequences and orders while still falling within the scope of the present disclosure. Accordingly, it is intended that the scope of patent protection is to be defined by the issued claim(s) rather than the description set forth herein.

Additionally, it is important to note that each term used herein refers to that which an ordinary artisan would understand such term to mean based on the contextual use of such term herein. To the extent that the meaning of a term used herein-as understood by the ordinary artisan based on the contextual use of such term-differs in any way from any particular dictionary definition of such term, it is intended that the meaning of the term as understood by the ordinary artisan should prevail.

Furthermore, it is important to note that, as used herein, “a” and “an” each generally denotes “at least one,” but does not exclude a plurality unless the contextual use dictates otherwise. When used herein to join a list of items, “or” denotes “at least one of the items,” but does not exclude a plurality of items of the list. Finally, when used herein to join a list of items, “and” denotes “all of the items of the list.”

The following detailed description refers to the accompanying drawings. Wherever possible, the same reference numbers are used in the drawings and the following description to refer to the same or similar elements. While many embodiments of the disclosure may be described, modifications, adaptations, and other implementations are possible. For example, substitutions, additions, or modifications may be made to the elements illustrated in the drawings, and the methods described herein may be modified by substituting, reordering, or adding stages to the disclosed methods. Accordingly, the following detailed description does not limit the disclosure. Instead, the proper scope of the disclosure is defined by the claims found herein and/or issuing here from. The present disclosure contains headers. It should be understood that these headers are used as references and are not to be construed as limiting upon the subjected matter disclosed under the header.

The present disclosure includes many aspects and features. Moreover, while many aspects and features relate to, and are described in the context of systems and methods for providing timestamp markers in content items, embodiments of the present disclosure are not limited to use only in this context.

In general, the method disclosed herein may be performed by one or more computing devices. For example, in some embodiments, the method may be performed by a server computer in communication with one or more client devices over a communication network such as, for example, the Internet. In some other embodiments, the method may be performed by one or more of at least one server computer, at least one client device, at least one network device, at least one sensor, and at least one actuator. Examples of the one or more client devices and/or the server computer may include, a desktop computer, a laptop computer, a smart television, a tablet computer, a personal digital assistant, a portable electronic device, a wearable computer, a smartphone, an Internet of Things (IoT) device, a smart electrical appliance, a video game console, a rack server, a super-computer, a mainframe computer, mini-computer, micro-computer, a storage server, an application server (e.g. a mail server, a web server, a real-time communication server, an FTP server, a virtual server, a proxy server, a DNS server, etc.), a quantum computer, and so on. Further, one or more client devices and/or the server computer may be configured for executing a software application such as, for example, but not limited to, an operating system (e.g. Windows, Mac OS, Unix, Linux, Android, etc.) in order to provide a user interface (e.g. GUI, touch-screen based interface, voice-based interface, gesture-based interface, etc.) for use by the one or more users and/or a network interface for communicating with other devices over a communication network. Accordingly, the server computer may include a processing device configured for performing data processing tasks such as, for example, but not limited to, analyzing, identifying, determining, generating, transforming, calculating, computing, compressing, decompressing, encrypting, decrypting, scrambling, splitting, merging, interpolating, extrapolating, redacting, anonymizing, encoding and decoding. Further, the server computer may include a communication device configured for communicating with one or more external devices. The one or more external devices may include, for example, but are not limited to, a client device, a third-party database, public database, a private database, and so on. Further, the communication device may be configured for communicating with the one or more external devices over one or more communication channels. Further, the one or more communication channels may include a wireless communication channel and/or a wired communication channel. Accordingly, the communication device may be configured for performing one or more of transmitting and receiving of information in electronic form. Further, the server computer may include a storage device configured for performing data storage and/or data retrieval operations. In general, the storage device may be configured for providing reliable storage of digital information. Accordingly, in some embodiments, the storage device may be based on technologies such as, but not limited to, data compression, data backup, data redundancy, deduplication, error correction, data finger-printing, role-based access control, and so on.

Further, one or more steps of the method disclosed herein may be initiated, maintained, controlled and/or terminated based on a control input received from one or more devices operated by one or more users such as, for example, but not limited to, an end-user, an admin, a service provider, a service consumer, an agent, a broker and a representative thereof. Further, the user as defined herein may refer to a human, an animal or an artificially intelligent being in any state of existence, unless stated otherwise, elsewhere in the present disclosure. Further, in some embodiments, the one or more users may be required to successfully perform authentication in order for the control input to be effective. In general, a user of the one or more users may perform authentication based on the possession of a secret human-readable secret data (e.g. username, password, passphrase, PIN, secret question, secret answer, etc.) and/or possession of a machine-readable secret data (e.g. encryption key, decryption key, bar codes, etc.) and/or possession of one or more embodied characteristics unique to the user (e.g. biometric variables such as, but not limited to, fingerprint, palm-print, voice characteristics, behavioral characteristics, facial features, iris pattern, heart rate variability, evoked potentials, brain waves, and so on) and/or possession of a unique device (e.g. a device with a unique physical and/or chemical and/or biological characteristic, a hardware device with a unique serial number, a network device with a unique IP/MAC address, a telephone with a unique phone number, a smartcard with an authentication token stored thereupon, etc.). Accordingly, the one or more steps of the method may include communicating (e.g. transmitting and/or receiving) with one or more sensor devices and/or one or more actuators in order to perform authentication. For example, the one or more steps may include receiving, using the communication device, the secret human-readable data from an input device such as, for example, a keyboard, a keypad, a touch-screen, a microphone, a camera and so on. Likewise, the one or more steps may include receiving, using the communication device, the one or more embodied characteristics from one or more biometric sensors.

Further, one or more steps of the method may be automatically initiated, maintained and/or terminated based on one or more predefined conditions. In an instance, the one or more predefined conditions may be based on one or more contextual variables. In general, the one or more contextual variables may represent a condition relevant to the performance of the one or more steps of the method. The one or more contextual variables may include, for example, but are not limited to, location, time, identity of a user associated with a device (e.g. the server computer, a client device, etc.) corresponding to the performance of the one or more steps, environmental variables (e.g. temperature, humidity, pressure, wind speed, lighting, sound, etc.) associated with a device corresponding to the performance of the one or more steps, physical state and/or physiological state and/or psychological state of the user, physical state (e.g. motion, direction of motion, orientation, speed, velocity, acceleration, trajectory, etc.) of the device corresponding to the performance of the one or more steps and/or semantic content of data associated with the one or more users. Accordingly, the one or more steps may include communicating with one or more sensors and/or one or more actuators associated with the one or more contextual variables. For example, the one or more sensors may include, but are not limited to, a timing device (e.g. a real-time clock), a location sensor (e.g. a GPS receiver, a GLONASS receiver, a GLONASS-K2 receiver, an indoor location sensor, etc.), a biometric sensor (e.g. a fingerprint sensor), an environmental variable sensor (e.g. temperature sensor, humidity sensor, pressure sensor, etc.) and a device state sensor (e.g. a power sensor, a voltage/current sensor, a switch-state sensor, a usage sensor, etc. associated with the device corresponding to performance of the or more steps).

Further, the one or more steps of the method may be performed one or more number of times. Additionally, the one or more steps may be performed in any order other than as exemplarily disclosed herein, unless explicitly stated otherwise, elsewhere in the present disclosure. Further, two or more steps of the one or more steps may, in some embodiments, be simultaneously performed, at least in part. Further, in some embodiments, there may be one or more time gaps between performance of any two steps of the one or more steps.

Further, in some embodiments, the one or more predefined conditions may be specified by the one or more users. Accordingly, the one or more steps may include receiving, using the communication device, the one or more predefined conditions from one or more and devices operated by the one or more users. Further, the one or more predefined conditions may be stored in the storage device. Alternatively, and/or additionally, in some embodiments, the one or more predefined conditions may be automatically determined, using the processing device, based on historical data corresponding to performance of the one or more steps. For example, the historical data may be collected, using the storage device, from a plurality of instances of performance of the method. Such historical data may include performance actions (e.g. initiating, maintaining, interrupting, terminating, etc.) of the one or more steps and/or the one or more contextual variables associated therewith. Further, machine learning may be performed on the historical data in order to determine the one or more predefined conditions. For instance, machine learning on the historical data may determine a correlation between one or more contextual variables and performance of the one or more steps of the method. Accordingly, the one or more predefined conditions may be generated, using the processing device, based on the correlation.

Further, one or more steps of the method may be performed at one or more spatial locations. For instance, the method may be performed by a plurality of devices interconnected through a communication network. Accordingly, in an example, one or more steps of the method may be performed by a server computer. Similarly, one or more steps of the method may be performed by a client computer. Likewise, one or more steps of the method may be performed by an intermediate entity such as, for example, a proxy server. For instance, one or more steps of the method may be performed in a distributed fashion across the plurality of devices in order to meet one or more objectives. For example, one objective may be to provide load balancing between two or more devices. Another objective may be to restrict a location of one or more of an input data, an output data, and any intermediate data therebetween corresponding to one or more steps of the method. For example, in a client-server environment, sensitive data corresponding to a user may not be allowed to be transmitted to the server computer. Accordingly, one or more steps of the method operating on the sensitive data and/or a derivative thereof may be performed at the client device.

### Overview

The present disclosure describes methods and systems for providing timestamp markers in content items. The present invention is preferably implemented as a software application that is executed on a computing device such as a personal computing device, a mobile device, or a server, among others.

Referring now to figures, FIG. 1 is an illustration of an online platform 100 consistent with various embodiments of the present disclosure. By way of non-limiting example, the online platform 100 to provide timestamp markers in content items may be hosted on a centralized server 102, such as, for example, a cloud computing service. The centralized server 102 may communicate with other network entities, such as, for example, a mobile device 106 (such as a smartphone, a laptop, a tablet computer, a smart television, etc.), other electronic devices 110 (such as desktop computers, server computers, etc.), and databases 114 over a communication network 104, such as, but not limited to, the Internet. Further, users of the online platform 100 may include relevant parties. Accordingly, in some instances, electronic devices operated by the one or more relevant parties may be in communication with the platform 100.

A user 112 may access the online platform 100 through a web-based software application or browser. The web-based software application may be embodied as, for example, but not be limited to, a website, a web application, a desktop application, and a mobile application compatible with a computing device 600.

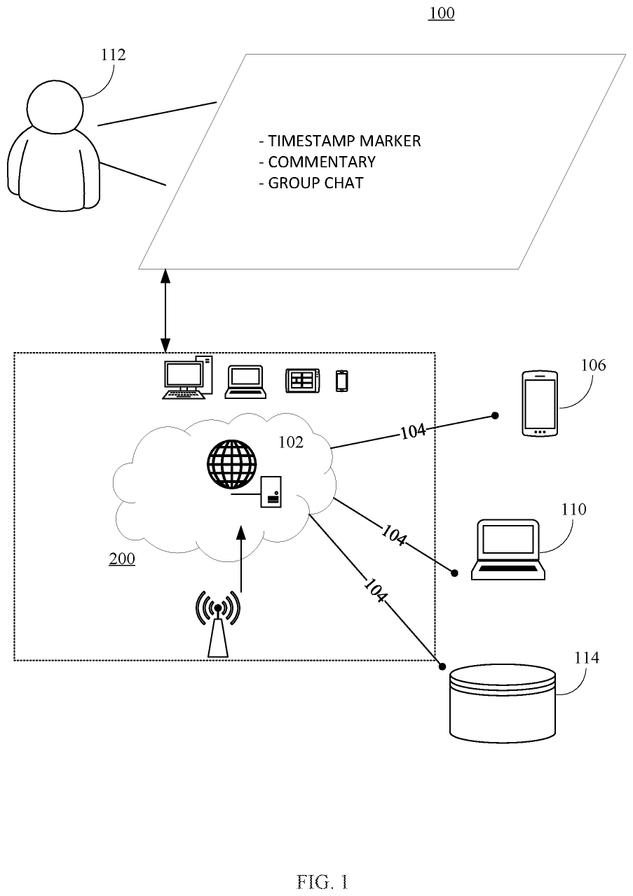

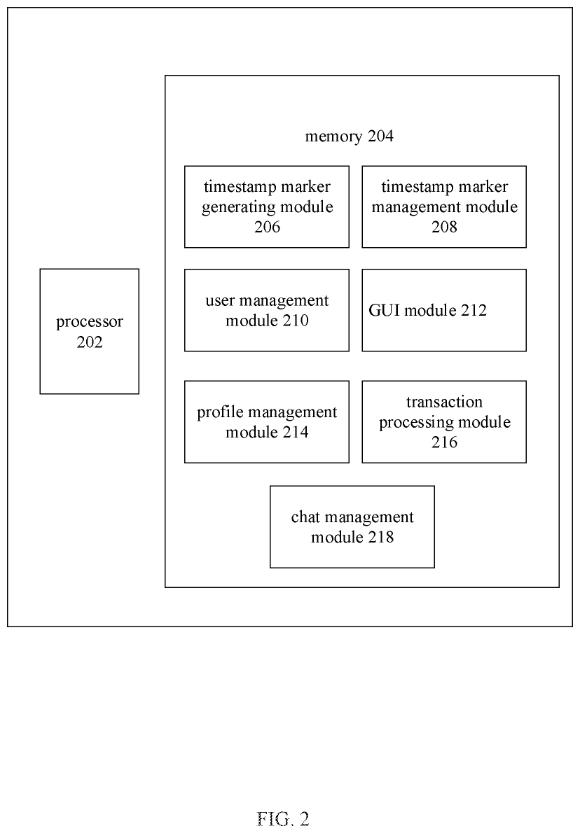

FIG. 2 is a block diagram of a system for providing timestamp markers in content items, in accordance with some embodiments. Accordingly, the system may include a processor 202 and a memory 204. The memory 204 may be used to store software programs and modules of application software. In one embodiment. The processor 202 runs the software programs and modules stored in memory 204 to perform various functional applications and data processing, that is, to implement the method for providing timestamp markers in content items. As used herein, the term “module” can encompass the processing and communication hardware and software appropriate to perform the function required. Moreover, as used herein, the term “content item” or “content items” is used to cover any content that is perceivable to the users. For example, content items may refer to television programs, commercials, movies, music, Internet content, live streams, video gaming, etc.

Memory 204 may include a high-speed random-access memory (RAM) and may also include non-volatile memory such as one or a plurality of magnetic storage apparatuses, a flash memory, or other non-volatile solid-state memories. In some examples, memory 204 may further include memories remotely provided with respect to the processor 202, and these remote memories may be connected to the processor 202 via a network. Examples of the aforementioned network include, but are not limited to, the Internet, intranets, local area networks, mobile communication networks, and the combinations thereof.

In one embodiment, the modules stored in the memory 204 comprise a timestamp marker generating module 206 and a timestamp marker management module 208. The timestamp marker generating module 206 is configured to receive a content item. In one embodiment, the content item is received from an online streaming platform or TV broadcasting over a communication network. An illustrative communication network includes, without limitation, a Wide Area Network (WAN), such as the Internet, a Local Area Network (LAN), a Personal Area Network (PAN), a cellular communications network, an IP Multimedia Subsystem (IMS) network, a SIP network, or combinations thereof.

The timestamp marker generating module 206 is further configured to receive a timestamp generating command from a first user device. The timestamp generating command may be input from a computer mouse, a keyboard, a touch-sensitive screen, a stylus, a mousepad, a joystick, a remote control, a smart wearable device, or any other user input mechanism. In one embodiment, the timestamp generating command may be created via a dedicated button on a remote connected via Bluetooth. In another embodiment, the timestamp generating command may be created via voice control. In yet another embodiment, the timestamp generating command may be created via hand gesture recognition. The timestamp generating command may be created with or without interruption or pause to the content item.

The timestamp marker generating module 206 is further configured to generate a timestamp marker that marks a time point in the content item upon receiving the timestamp generating command. Timestamp markers allow the user to archive points or locations of interest (i.e., a scene) in the content item. In one embodiment, the content item may be a video file. In this embodiment, the timestamp marker may comprise a frame of the video file. The frame of the video file may be translucent or opaque. The user is able to view the frame of the video file. In another embodiment, the timestamp marker is associated with a period of time corresponding to when the timestamp marker is generated. In this embodiment, the timestamp marker generating module 206 may be further configured to allow the user to associate a video with the timestamp marker. The video may be stored in an online video sharing and social media platform (such as YouTube, Facebook, etc.) or in the computing device of the present invention. It also should be noted that the length of the video associated with the timestamp marker may be customized by the user. For example, the timestamp marker may comprise a frame captured when the timestamp marker is generated. In another example, the timestamp marker may comprise a video that has a customizable length (e.g., 1-5 seconds prior to the time the timestamp marker is generated). In one embodiment, the timestamp markers may also comprise the date and time when the timestamp markers are generated, and the timestamp markers may be stored and sorted in chronological order.

The timestamp marker management module 208 is configured to store the timestamp marker. Further, timestamp marker management module 208 is configured to receive a timestamp retrieving command from the first user device. The timestamp retrieving command indicates that the user wants to view the timestamp marker. Similar to the timestamp generating command, the timestamp retrieving command may be input from a computer mouse, a keyboard, a touch-sensitive screen, a stylus, a mousepad, a joystick, a remote control, or any other user input mechanism. In one embodiment, the timestamp retrieving command may be created via a dedicated button on a remote. In another embodiment, the timestamp retrieving command may be created via voice control. In yet another embodiment, the timestamp retrieving command may be created via hand gesture recognition.

The timestamp marker management module 208 is further configured to retrieve the timestamp marker upon receiving the timestamp retrieving command to allow playback from the time point. This also enables the user to view the content associated with or included in the timestamp marker (e.g., a frame of the video file, annotations, comments, etc.).

In one embodiment, the timestamp marker management module 208 is further configured to receive an annotation from the first user device and adding the annotation to the timestamp marker. This allows users to commentate and annotate on the scene marked by the timestamp marker. For instance, the user may commentate on the scene of the timestamp using Emojis, Agree & Disagree symbols, Scale of agreement to disagreement (such as 0-10), or any other desired visual and audio commentary methods. The user may also set up a default commentary on newly created timestamps.

In one embodiment, the timestamp marker management module 208 is further configured to generate a quick response (QR) code associated with the timestamp marker. The user can share this QR code with particular users, such as the user's friends, or make it public such that the QR code is available to all other users on the platform. Other users may access the timestamp by scanning the QR code. In another embodiment, a shared QR code may be generated for a content item (a movie, a live sports game, etc.). Users scanning the shared QR code are synchronized to the content item. Moreover, each user's timestamps will be shown on the content item. All the timestamps can be archived to be later retrieved by analysts to commentate on and review.

In one embodiment, the timestamp marker management module 208 is further configured to categorize the timestamp maker based on a user-defined rule. For example, the timestamp maker may be categorized into different categories based on the classification/genre of the content items, such as but not limited to movies, TVs, sports, news, etc. Each category may further be divided into a plurality of sub-categories. For example, movies may be divided into horror, thriller, drama, adventure, sci-fi, documentary, crime, family, mystery, romance, etc. In one embodiment, the timestamp marker management module 208 is further configured to provide analytic information regarding the timestamp makers. For example, the timestamp marker management module 208 may provide information on how many timestamp markers have been generated in each category. In another example, the timestamp marker management module 208 may provide a real-time counter that shows the numbers and percentages of timestamp markers in their respective categories and genres being made in real time.

In one embodiment, the timestamp marker management module 208 is further configured to share the timestamp marker to at least one second user device. This enables a user to share the timestamp marker with other users and allows other users to view the timestamp marker and the associated information thereof. Further, the timestamp marker management module 208 may be configured to receive comments from the at least one second user device and add the comments from the at least one second user device to the timestamp marker. In this way, other users may commentate on the timestamp marker that was shared by a user. In another embodiment, the timestamp marker may be shared while the content item is being played on the first user device. The timestamp marker management module 208 may be further configured to receive a joining request from the at least one second user device, determine whether to accept the joining request, and synchronize the content item being played on the first user device and the at least one second user device upon acceptance of the joining request. The user may also invite other users to watch the same content item concurrently on different user devices. In one embodiment, all the users watching the same content item may be able to see each other's timestamp markers of the content item being watched.

One or more of the following modules may also be included to facilitate the operation of the present invention: a user management module 210, a GUI (Graphical User Interface) module 212, a profile management module 214, a transaction processing module 216, and a chat management module 218.

The user management module 210 is configured to register users in the platform and perform authentication of the users. The users need to provide their registration information to create an account on the platform. The user management module receives each user's registration information and creates accounts accordingly. For example, the user's registration information can include but not limited to username, gender, phone number, password, etc. In one embodiment, the user management module 210 generates login credentials for the user based on the user's registration information and stores the login credentials in the database. In this way, each user is able to access the platform using the login credentials from their smartphones, laptops, desktops, etc. It should be understood that the present invention may also employ other authentication schemes, including but not limited to graphical passwords, pattern locks, and biometrics.

The GUI module 212 generates graphical data for displaying a user interface that enables the users to interact with the present invention. A user can input information into the user interface and the GUI module 212 relays the information to other modules for further processing. For example, the user interface may include a login box into which the users can enter login credentials, and then the credentials are transmitted from the user interface module to the user management module for user authentication. If the login credentials do not match with those in the database, the GUI module 212 will generate a pop-up window requiring the user to re-enter the credentials. In another embodiment, the GUI module 212 also presents visual or audio prompts (such as Emojis) that allow users to commentate on the timestamps.

The profile management module 214 receives and stores the profile information of the user. The profile information can be input by users when creating the accounts. In one embodiment, the profile information may comprise name, age, occupation, hobby, favorite movie, location, bio, etc. Moreover, the profile management module 214 further allows users to store and retrieve their timestamp markers. A user can also choose which timestamp markers are available to other users.

The transaction processing module 216 is configured to receive a transaction from a user regarding one or more services in the platform; bill the user for the use of the one or more services associated with the user; and transmit a response regarding the transaction to the user. The transaction processing module 216 enables users to purchase additional features of the platform (for example, additional commentary symbols, screenshot/video storage service, etc.).

The chat management module 218 is configured to allow a user to chat with other users while a group of users are watching, for example, a movie, a live sports game, etc. In one embodiment, the group chat may be initiated by scanning a shared QR code. When a group member creates a timestamp, other members in the group will be able to immediately see the created timestamp and react to the timestamp.

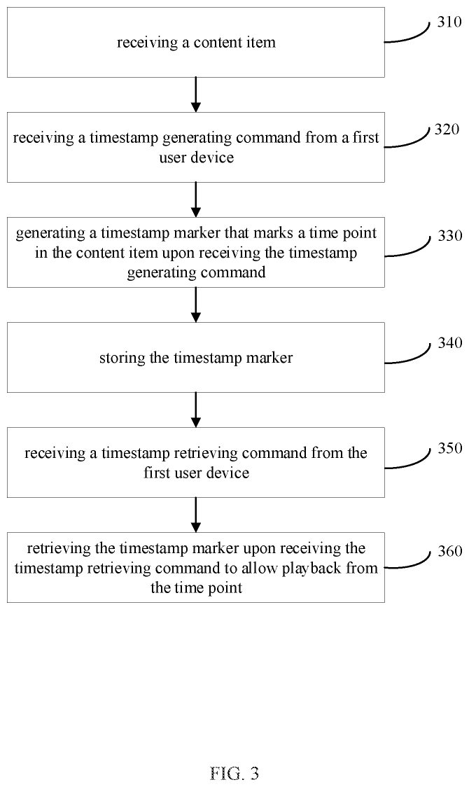

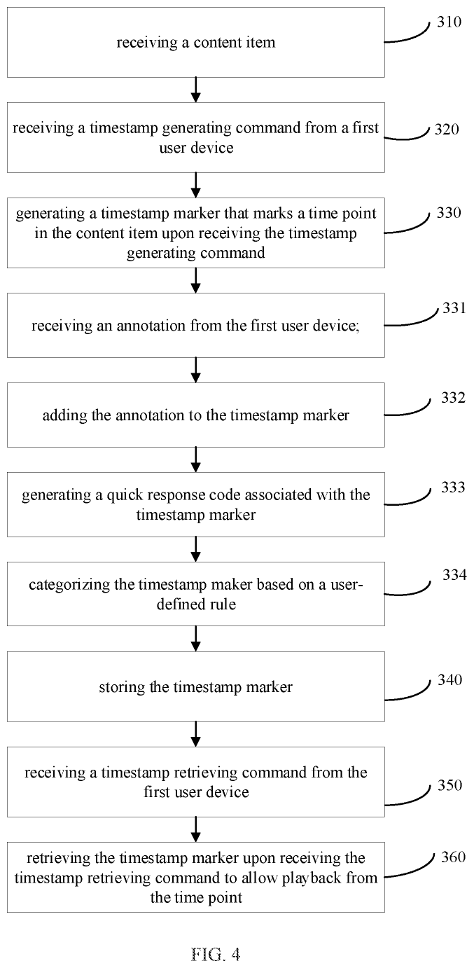

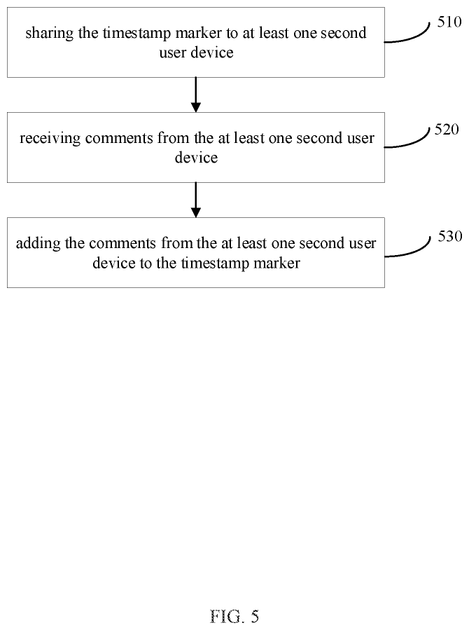

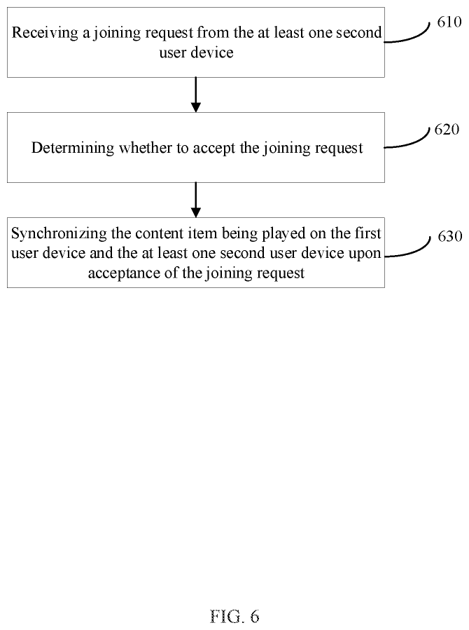

FIGS. 3-6 are flowcharts of a method for providing timestamp markers in content items. The method comprises the following steps: receiving at step 310 a content item; receiving at step 320 a timestamp generating command from a first user device; generating at step 330 a timestamp marker that marks a time point in the content item upon receiving the timestamp generating command; storing at step 340 the timestamp marker; receiving at step 350 a timestamp retrieving command from the first user device; and retrieving at step 360 the timestamp marker upon receiving the timestamp retrieving command to allow playback from the time point.

In one embodiment, the method further comprises: receiving at step 331 an annotation from the first user device; and adding at step 332 the annotation to the timestamp marker. In one embodiment, the method further comprises generating at step 333 a quick response code associated with the timestamp marker. In one embodiment, the method further comprises categorizing at step 334 the timestamp maker based on a user-defined rule.

In a preferred embodiment, the content item is a video file. The timestamp marker may comprise a frame of the video file. The timestamp marker may correspond to a period of time starting from the time point marked by the timestamp marker.

In one embodiment, the method further comprises sharing at step 510 the timestamp marker to at least one second user device. In a further embodiment, the method further comprises receiving at step 520 comments from the at least one second user device; and adding at step 530 the comments from the at least one second user device to the timestamp marker.

In one embodiment where the timestamp marker is shared while the content item is being played on the first user device, the method further comprises receiving at step 610 a joining request from the at least one second user device; determining at step 620 whether to accept the joining request; synchronizing at step 630 the content item being played on the first user device and the at least one second user device upon acceptance of the joining request.

Generally, consistent with embodiments of the disclosure, program modules may include routines, programs, components, data structures, and other types of structures that may perform particular tasks or that may implement particular abstract data types. Moreover, embodiments of the disclosure may be practiced with other computer system configurations, including hand-held devices, general-purpose graphics processor-based systems, multiprocessor systems, microprocessor-based or programmable consumer electronics, application-specific integrated circuit-based electronics, minicomputers, mainframe computers, and the like. Embodiments of the disclosure may also be practiced in distributed computing environments where tasks are performed by remote processing devices that are linked through a communications network. In a distributed computing environment, program modules may be located in both local and remote memory storage devices.

Furthermore, embodiments of the disclosure may be practiced in an electrical circuit comprising discrete electronic elements, packaged or integrated electronic chips containing logic gates, a circuit utilizing a microprocessor, or on a single chip containing electronic elements or microprocessors. Embodiments of the disclosure may also be practiced using other technologies capable of performing logical operations such as, for example, AND, OR, and NOT, including but not limited to mechanical, optical, fluidic, and quantum technologies. In addition, embodiments of the disclosure may be practiced within a general-purpose computer or in any other circuits or systems.

Embodiments of the disclosure, for example, may be implemented as a computer process (method), a computing system, or as an article of manufacture, such as a computer program product or computer-readable media. The computer program product may be a computer storage media readable by a computer system and encoding a computer program of instructions for executing a computer process. The computer program product may also be a propagated signal on a carrier readable by a computing system and encoding a computer program of instructions for executing a computer process. Accordingly, the present disclosure may be embodied in hardware and/or in software (including firmware, resident software, micro-code, etc.). In other words, embodiments of the present disclosure may take the form of a computer program product on a computer-usable or computer-readable storage medium having computer-usable or computer-readable program code embodied in the medium for use by or in connection with an instruction execution system. A computer-usable or computer-readable medium may be any medium that can contain, store, communicate, propagate, or transport the program for use by or in connection with the instruction execution system, apparatus, or device.

The computer-usable or computer-readable medium may be, for example, but not limited to, an electronic, magnetic, optical, electromagnetic, infrared, or semiconductor system, apparatus, device, or propagation medium. More specific computer-readable medium examples (a non-exhaustive list), the computer-readable medium may include the following: an electrical connection having one or more wires, a portable computer diskette, a random-access memory (RAM), a read-only memory (ROM), an erasable programmable read-only memory (EPROM or Flash memory), an optical fiber, and a portable compact disc read-only memory (CD-ROM). Note that the computer-usable or computer-readable medium could even be paper or another suitable medium upon which the program is printed, as the program can be electronically captured, via, for instance, optical scanning of the paper or other medium, then compiled, interpreted, or otherwise processed in a suitable manner, if necessary, and then stored in a computer memory.

Embodiments of the present disclosure, for example, are described above with reference to block diagrams and/or operational illustrations of methods, systems, and computer program products according to embodiments of the disclosure. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

While certain embodiments of the disclosure have been described, other embodiments may exist. Furthermore, although embodiments of the present disclosure have been described as being associated with data stored in memory and other storage mediums, data can also be stored on or read from other types of computer-readable media, such as secondary storage devices, like hard disks, solid-state storage (e.g., USB drive), or a CD-ROM, a carrier wave from the Internet, or other forms of RAM or ROM. Further, the disclosed methods' stages may be modified in any manner, including by reordering stages and/or inserting or deleting stages, without departing from the disclosure.

Although the present disclosure has been explained in relation to its preferred embodiment. it is to be understood that many other possible modifications and variations can be made without departing from the spirit and scope of the disclosure.

The following is claimed:

1. A method for providing timestamp markers in content items, comprising:
receiving a content item;
receiving a timestamp generating command from a first user device;
generating a timestamp marker that marks a time point in the content item upon receiving the timestamp generating command;
storing the timestamp marker;
receiving a timestamp retrieving command from the first user device; and
retrieving the timestamp marker upon receiving the timestamp retrieving command to allow playback from the time point.

2. The method as claimed in claim 1, further comprising:
receiving an annotation from the first user device; and
adding the annotation to the timestamp marker.

3. The method as claimed in claim 1, further comprising:
generating a quick response code associated with the timestamp marker.

4. The method as claimed in claim 1, further comprising:
categorizing the timestamp maker based on a user-defined rule.

5. The method as claimed in claim 1, wherein the content item is a video file.

6. The method as claimed in claim 5, wherein the timestamp marker comprises a frame of the video file.

7. The method as claimed in claim 6, wherein the timestamp marker is associated with a period of time corresponding to when the timestamp marker is generated.

8. The method as claimed in claim 1, further comprising:
sharing the timestamp marker to at least one second user device.

9. The method as claimed in claim 8, further comprising:
receiving comments from the at least one second user device; and
adding the comments from the at least one second user device to the timestamp marker.

10. The method as claimed in claim 9, wherein the timestamp marker is shared while the content item is being played on the first user device, the method further comprises:
receiving a joining request from the at least one second user device;
determining whether to accept the joining request; and
synchronizing the content item being played on the first user device and the at least one second user device upon acceptance of the joining request.

11. A system for providing timestamp markers in content items, comprising:
a processor;
a memory, wherein modules are stored on the memory for execution by the processor, the modules comprising:
a timestamp marker generating module;
a timestamp marker management module;
the timestamp marker generating module being configured for:
receiving a content item;
receiving a timestamp generating command from a first user device; and
generating a timestamp marker that marks a time point in
the content item upon receiving the timestamp generating command;
the timestamp marker management module being configured for:
storing the timestamp marker;
receiving a timestamp retrieving command from the first user device; and
retrieving the timestamp marker upon receiving the timestamp retrieving command to allow playback from the time point.

12. The system as claimed in claim 11, wherein the timestamp marker management module is further configured for:
receiving an annotation from the first user device; and
adding the annotation to the timestamp marker.

13. The system as claimed in claim 11, wherein the timestamp marker management module is further configured for:
generating a quick response code associated with the timestamp marker.

14. The system as claimed in claim 11, wherein the timestamp marker management module is further configured for:
categorizing the timestamp maker based on a user-defined rule.

15. The system as claimed in claim 11, wherein the content item is a video file.

16. The system as claimed in claim 15, wherein the timestamp marker comprises a frame of the video file.

17. The system as claimed in claim 16, wherein the timestamp marker is associated with a period of time corresponding to when the timestamp marker is generated.

18. The system as claimed in claim 11, wherein the timestamp marker management module is further configured for:
sharing the timestamp marker to at least one second user device.

19. The system as claimed in claim 18, wherein the timestamp marker management module is further configured for:
receiving comments from the at least one second user device; and
adding the comments from the at least one second user device to the timestamp marker.

20. The system as claimed in claim 19, wherein the timestamp marker is shared while the content item is being played on the first user device, and the timestamp marker management module is further configured for:
receiving a joining request from the at least one second user device;
determining whether to accept the joining request; and
synchronizing the content item being played on the first user device and the at least one second user device upon acceptance of the joining request.
